(19) United States
(12) Patent Application Publication
(10) Pub. No.: US 2009/0162059 A1
(43) Pub. Date: Jun. 25, 2009

(54) WAVELENGTH DIVISION MULTIPLEXING TRANSMISSION SYSTEM

(75) Inventor: Hiroshi NAKAMOTO, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/338,482

(22) Filed: Dec. 18, 2008

(30) Foreign Application Priority Data
Dec. 19, 2007 (JP) 2007-327229

(51) Int. Cl. H04J 14/00; H04J 14/02

(52) U.S. Cl. 398/48; 398/79

(57) ABSTRACT

A wavelength division multiplexing transmission system in which a first channel using an intensity modulation scheme and a second channel using a phase modulation scheme are present includes a polarization scrambler inserted into a signal path of either one of the first channel and the second channel to perform polarization scrambling, and a drive unit configured to drive the polarization scrambler at frequency greater than or equal to a value defined as: (bit rate of phase modulated signal)/(error correction frame length)×2.

### CROSS-REFERENCE TO RELATED APPLICATIONS

The present application is based upon and claims the benefit of priority from the prior Japanese Patent Application No. 2007-327229 filed on Dec. 19, 2007, with the Japanese Patent Office, the entire contents of which are incorporated herein by reference.

### BACKGROUND OF THE INVENTION

1. Field of the Invention

The disclosures herein relate to a technology for providing additional channels in a WDM (wavelength division multiplexing) transmission apparatus.

2. Description of the Related Art

There is a demand for an increase in the transmission capacity of a submarine optical cable system in response to an increase in communication traffic. Generally, countermeasures as follows may be taken to meet such demand.

A new submarine optical cable is laid down, and a submarine line terminal is constructed.

A new submarine line terminal is added to a submarine optical cable that is laid down but unused (generally referred to as a “dark fiber”).

A new channel is added to an optical communication equipment that is already installed (which is generally referred to as an “upgrading method”). This upgrading method does not require an additional submarine optical cable or additional submarine line terminal, and is thus preferable from the viewpoint of increasing transmission capacity at low cost.

Further, the upgrading method includes:

a method of adding a transponder to an unused port for multiplexing/demultiplexing provided on the transmission and reception side; and

providing an optical branch on both the transmission side and the reception side of an already operational optical communication equipment to install a new optical terminal.

The method of adding a transponder to an unused port for multiplexing/demultiplexing is applicable only when such an unused port is in existence. Such method thus cannot serve as a universally applicable method for increasing transmission capacity. It follows that the method of installing a new optical terminal by providing an optical branch is preferable. The method (i) described above is of course effective if there is an unused port. The applicability of this method should not be entirely discarded.

FIGS. 1A through 1C are drawings showing an example of channel addition by the method of installing a new optical terminal by providing an optical branch. FIG. 1A illustrates a preexisting configuration prior to channel addition. An existing optical terminal 2A on the transmission side is connected to an end of an optical cable 1. An existing optical terminal 2B on the reception side is connected to the other end of the optical cable 1. The existing optical terminal 2A includes transponders 21-1A through 21-4A having respective channels ch1 through ch4 assigned thereto, a multiplexer/demultiplexer unit 22A for multiplexing the optical outputs of the transponders 21-1A through 21-4A, and an optical amplifier 23A for amplifying the optical output of the multiplexer/demultiplexer unit 22A for provision to the optical cable 1. The existing optical terminal 2B on the reception side has a similar configuration. Namely, the existing optical terminal 2B includes transponders 21-1B through 21-4B, a multiplexer/demultiplexer unit 22B, and an optical amplifier 23B.

FIG. 1B illustrates a configuration after channel addition. A new optical terminal 3A is inserted between the optical cable 1 and the existing optical terminal 2A on the transmission side. Further, a new optical terminal 3B is inserted between the optical cable 1 and the existing optical terminal 2B on the reception side. The new optical terminal 3A includes transponders 31-1A through 31-4A having respective new channels ch5 through ch8 assigned thereto, a multiplexer/demultiplexer unit 32A for multiplexing the optical outputs of the transponders 31-1A through 31-4A, an optical amplifier 33A for amplifying the optical output of the multiplexer/demultiplexer unit 32A, a variable optical attenuator 34A for adjusting the level of the optical output from the optical amplifier 33A, a variable optical attenuator 35A for adjusting the level of the optical output from the existing optical terminal 2A, an optical coupler 36A for combining the optical output of the variable optical attenuator 34A and the optical output of the variable optical attenuator 35A, and an optical amplifier 37A for amplifying the optical output of the optical coupler 36A for provision to the optical cable 1. The new optical terminal 3B on the reception side has a similar configuration. Namely, the new optical terminal 3B includes transponders 31-1B through 31-4B, a multiplexer/demultiplexer unit 32B, an optical amplifier 33B, a variable optical attenuator 34B, a variable optical attenuator 35B, an optical coupler 36B, and an optical amplifier 37B. FIG. 1C illustrates an example of the wavelengths of individual channels. In this example, the existing channels ch1 through ch4 are positioned near the center where characteristics are favorable, and the new channels ch5 through ch8 are situated outside the existing channels. This arrangement is not intended to be a limiting example, and any arrangement is possible.

While an NRZ (Non Return to Zero) scheme is typically employed as an encoding scheme in land optical communication systems, a RZ-OOK (Return to Zero On Off Keying) scheme is typically employed as an optical modulation scheme for use in submarine communication. The RZ scheme may require a transmitter having a complex configuration, but provides advantages such as superior receiver sensitivity and relatively small signal degradation (transmission degradation) for a long distance transmission through an optical fiber.

Here, nonlinear characteristics of an optical fiber cause transmission degradation. Such causes include self phase modulation (SPM) and cross phase modulation (XPM). SPM refers to a phenomenon in which the refractive index of optical fiber changes in response to the channel optical power to cause phase modulation. Such phase modulation causes the optical spectrum to spread, resulting in the distortion of optical waveform due to the dispersion characteristics of the transmission fiber. XPM refers to a phenomenon in which the refractive index of optical fiber changes in response to the optical power of an adjacent channel to cause phase modulation. This phase modulation causes a distortion in the optical waveform due to the dispersion characteristics of the transmission fiber. There is another nonlinear effect of optical fiber referred to as four wave mixing (FWM). This effect is avoidable by creating a difference in propagation speed between WDM-signal channels. Specifically, FWM can be avoided by using an optical fiber having a chromatic dispersion of −2 [ps/nm/km] more or less.

In recent years, the application of a RZ-DPSK (Differential Phase Shift Keying) scheme using optical phase to carry signals has been studied for the purpose of further improving receiver sensitivity (see Patent Document 1). In the RZ-DPSK scheme, the transmitter may have a more complex configuration that that of the RZ-OOK scheme. Receiver sensitivity of the RZ-DPSK scheme, however, is expected to be 3 dB higher than receiver sensitivity of the RZ-OOK scheme. In detail, receiver sensitivity is approximately doubled by use of a configuration in which a 1-bit delay optical interferometer is provided on the reception side to divide the output path according to “0/1” of the optical signal, and a pair of balanced photodiodes is used to receive light.

As described above, providing an optical branch on the transmission side and reception side of an existing optical communication equipment to install an additional optical terminal is a preferable upgrading method for adding a channel to an existing submarine optical cable system. It is further preferable to use the RZ-DPSK scheme for the additional channel. It should be further noted that the use of the RZ-DPSK scheme for an additional channel is preferable even when the upgrading method that adds a transponder to an unused port for multiplexing/demultiplexing is employed.

The use of the RZ-DPSK scheme in an upgrading method is expected to provide the following advantages.

It is possible to achieve high channel density because spectrum broadening is smaller than the RZ-OOK scheme.

Even when the RZ-OOK scheme suffers large penalty (degradation in error rate) and cannot guarantee transmission quality because of large cumulative dispersion, the RZ-DPSK scheme may properly be employed due to its superior receiver sensitivity.

In the above-described upgrading methods ((i) and (ii)), an existing transponder that is adjacent to an additional transponder in the wavelength domain may employ the RZ-OOK scheme rather than the RZ-DPSK scheme. In such a case, the characteristics of the additional transponder may degrade due to interaction between the two transponders. While the RZ-DPSK scheme may be used for a new installment, most of the existing transponders employ the RZ-OOK scheme. It is thus highly likely that a channel using the RZ-OOK scheme is situated adjacent to a channel using the RZ-DPSK scheme in the wavelength domain. A risk of suffering degradation is rather high.

FIG. 2 is a drawing showing an example of an effect that a channel employing the RZ-OOK scheme has on a channel employing the RZ-DPSK scheme. In the channel using the RZ-OOK scheme illustrated in FIG. 2, the optical intensity carries information, but the optical phase does not carry information. In the channel using the RZ-DPSK scheme, the optical phase carries information, and the optical intensity is comprised of repetition of the same waveform. Accordingly, XPM responsive to the optical intensity of the RZ-OOK-scheme channel is added to the RZ-DPSK-scheme channel to cause large signal degradation.

XPM causing this problem is dependent on relative polarization between two optical signals. XPM becomes minimum when the polarizations are perpendicular to each other, and becomes maximum when the polarizations are parallel to each other. Relative polarization between two optical signals exhibits extremely slow fluctuation (in a cycle of a few seconds or more) due to changes in the environmental conditions of a terminal equipment. The worst polarization condition may last more than a few seconds to cause burst errors.

Forward error correction (FEC) is used to compensate for signal quality degradation. It is well known, however, that FEC cannot correct error if a poor error rate condition (i.e., a condition in which the error rate exceeds a correctable burst error rate) lasts more than a certain time period (e.g., the length of an FEC correction frame). Under such circumstances, the error rate of the FEC output may not be improved, or may even be worse. In order to correct burst errors, a correction frame needs to have at least two portions where no burst error is present. This is because the correction of a portion suffering burst errors requires adjacent areas suffering no burst errors ahead of and behind the portion.

FIGS. 3A and 3B are drawings showing examples of error correction depending on the relationship between an error rate fluctuation period and an error correction frame period. FIG. 3A illustrates a case in which the error correction frame period is shorter than the period in which the bit error rate (BER) exceeds a correctable burst error rate. In this case, application of error correction causes an error-uncorrectable state. FIG. 3B illustrates a case in which the error correction frame period is longer than the error rate fluctuation period. In this case, a correction frame always has at least two portions suffering no burst error even when the bit error rate sometimes exceeds the correctable burst error rate. Correction of a portion suffering burst errors can thus be performed to take advantage of the error correction process.

As previously described, error rate fluctuation occurs due to changes in relative polarization between two optical signals resulting from changes in the environmental conditions of a terminal equipment. It is thus difficult to predict and control the error rate fluctuation. Since such fluctuation often has a period of a few seconds or more, it is desirable to provide a countermeasure to prevent the occurrence of error-uncorrectable state. The above description has been provided with respect to a case in which XPM responsive to the optical intensity of an RZ-OOK channel affects an RZ-DPSK channel. A channel using any other intensity modulation scheme (e.g., NRZ scheme) in place of the RZ-OOK scheme may also have similar effects on a channel using a phase modulation scheme (e.g., DPSK, DQPSK (Quadrature Phase Shift Keying), or RZ-DQPSK) other than the RZ-DPSK scheme.

Patent Document 1 discloses a technology for scrambling the polarization of incident light in order to achieve high-density wavelength multiplexing and also to prevent S/N fluctuation and polarization-dependent fading induced by optical devices. This technology does not take into account a situation in which a channel is added to an existing optical terminal, and, thus, cannot obviate the problems described above.

Patent Document 2 discloses a technology for generating orthogonal polarization WDM signals for which dispersion compensation is made in advance for the purpose of adding a new channel to an optical transmission apparatus. This technology does not take into account the effect that XPM responsive to the optical intensity of an intensity-modulated channel has on another channel utilizing phase modulation, and, thus, cannot obviate the problems described above.

Patent Document 3 discloses a technology for reducing penalty caused by polarization mode dispersion, polarization-dependent loss, and polarization-dependent gain in optical communication systems. This technology does not take into account the effect that XPM responsive to the optical intensity of an intensity-modulated channel has on another channel utilizing phase modulation, and, thus, cannot obviate the problems described above.

There is thus a need to provide a wavelength division multiplexing transmission system that can prevent the occurrence of a time period in which error correction cannot be performed to correct errors caused by XPM between a channel using an intensity modulation scheme such as the RZ-OOK scheme and a channel using a phase modulation scheme such as the RZ-DPSK scheme in the environment in which the bit error rate exhibits extremely slow fluctuation.

[Patent Document 1] Japanese Patent Application Publication No. 10-285144

[Patent Document 2] Japanese Patent Application Publication No. 2001-103006

[Patent Document 3] Japanese Patent Application Publication No. 2005-65273

[Non-patent Document 1] JORNAL OF LIGHTWAVE TECHNOLOGY, VOL. 23, NO. 1, JANUARY 2005, pp 95-103, “RZ-DPSK Field Trial Over 13100 km of Installed Non-Slope-Matched Submarine Fibers.”

### SUMMARY OF THE INVENTION

It is a general object of the present invention to provide a wavelength division multiplexing transmission system and a method of controlling a wavelength division multiplexing transmission system that substantially obviate one or more problems caused by the limitations and disadvantages of the related art.

In one embodiment, a wavelength division multiplexing transmission system in which a first channel using an intensity modulation scheme and a second channel using a phase modulation scheme are present includes a polarization scrambler inserted into a signal path of either one of the first channel and the second channel to perform polarization scrambling, and a drive unit configured to drive the polarization scrambler at frequency greater than or equal to a value defined as: (bit rate of phase modulated signal)/(error correction frame length)×2.

In another embodiment, a method of controlling a wavelength division multiplexing transmission system in which a first channel using an intensity modulation scheme and a second channel using a phase modulation scheme are present includes driving a polarization scrambler inserted into a signal path of either one of the first channel and the second channel at frequency greater than or equal to a value defined as: (bit rate of phase modulated signal)/(error correction frame length)×2.

The system described above is not only applicable to the upgrading method of installing a new optical terminal by providing an optical branch in an existing optical communication equipment on the transmission side and the reception side, but also applicable to the upgrading method of adding a transponder to an unused port for multiplexing/demultiplexing.

According to at least one embodiment, in a wavelength division multiplexing transmission system in which a channel using an intensity modulation scheme and a channel using a phase modulation scheme are present, a length of burst errors can be set shorter than an error correction frame period even in an environment in which a bit error rate exhibits extremely slow fluctuation due to an effect of the intensity-modulated channel on the phase-modulated channel. Further, the number of portions suffering no bust error in one error correction frame becomes two or more, which can prevent the occurrence of error-uncorrectable state and signal quality degradation.

### BRIEF DESCRIPTION OF THE DRAWINGS

Other objects and further features of the present invention will be apparent from the following detailed description when read in conjunction with the accompanying drawings, in which:

FIGS. 1A through 1C are drawings showing an example of channel addition by a method of installing a new optical terminal by providing an optical branch;

FIG. 2 is a drawing showing an example of an effect that a channel employing the RZ-OOK scheme has on a channel employing the RZ-DPSK scheme;

FIGS. 3A and 3B are drawings showing examples of error correction depending on the relationship between an error rate fluctuation period and an error correction frame period;

FIG. 4 is a drawing showing an example of the configuration of a transmission side of a system according to a first embodiment;

FIG. 5 is a drawing showing an example of the configuration of a transmission side of a system according to a second embodiment;

FIG. 6 is a drawing showing an example of the configuration of a receiver unit of a reception-side transponder using the RZ-DPSK scheme;

FIG. 7 is a drawing showing an example of the configuration of a system according to a third embodiment;

FIG. 8 is a drawing showing an example of the configuration that generates a drive signal for driving polarization scramblers on the reception side;

FIG. 9 is a drawing showing an example of the configuration of a polarization-independent polarization scrambler;

FIG. 10 is a drawing showing an example of the configuration of a transmission side of a system according to a fourth embodiment;

FIG. 11 is a drawing showing an example of the configuration of a system according to a fifth embodiment; and

FIG. 12 is a flowchart showing an example of a process performed by a monitor circuit.

### DESCRIPTION OF THE PREFERRED EMBODIMENTS

In the following, embodiments of the present invention will be described with reference to the accompanying drawings.

### First Embodiment

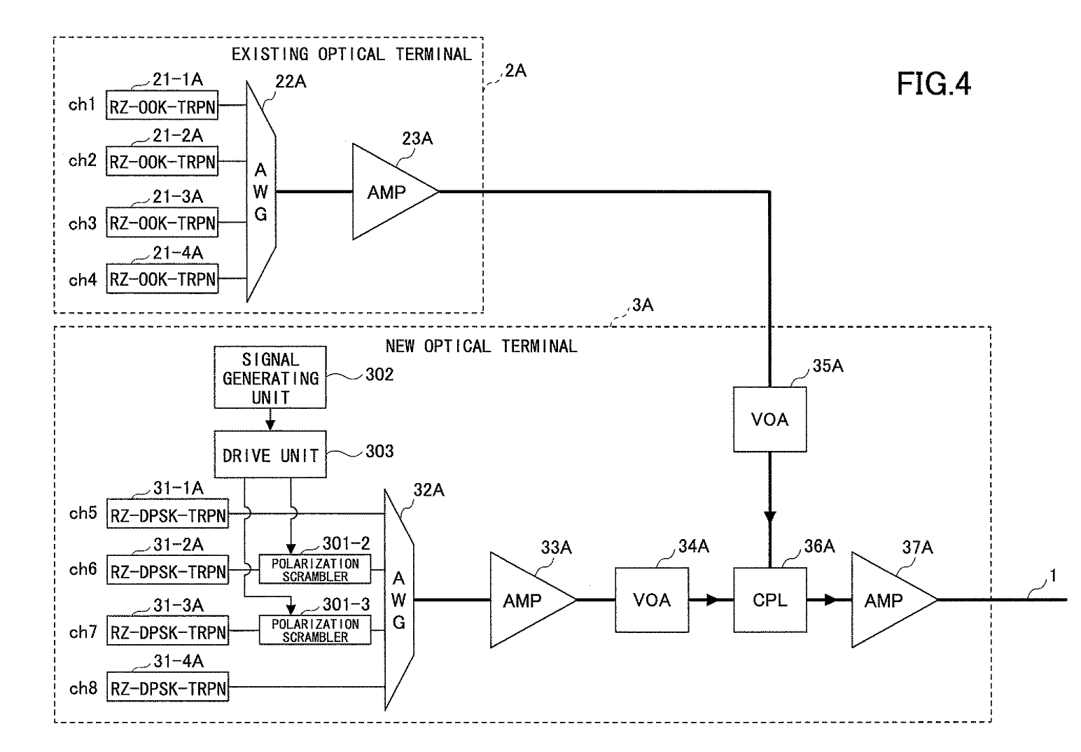

FIG. 4 is a drawing showing an example of the configuration of a transmission side of a system according to a first embodiment.

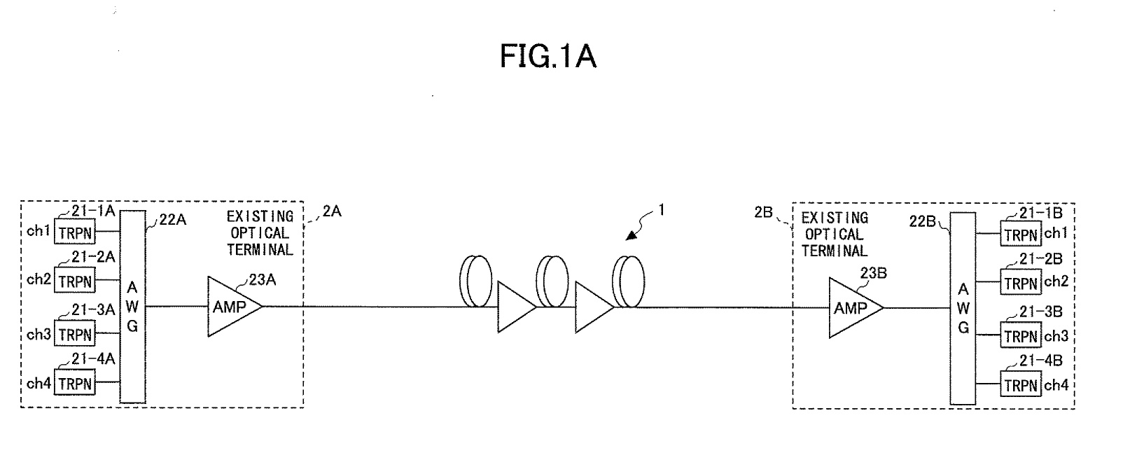

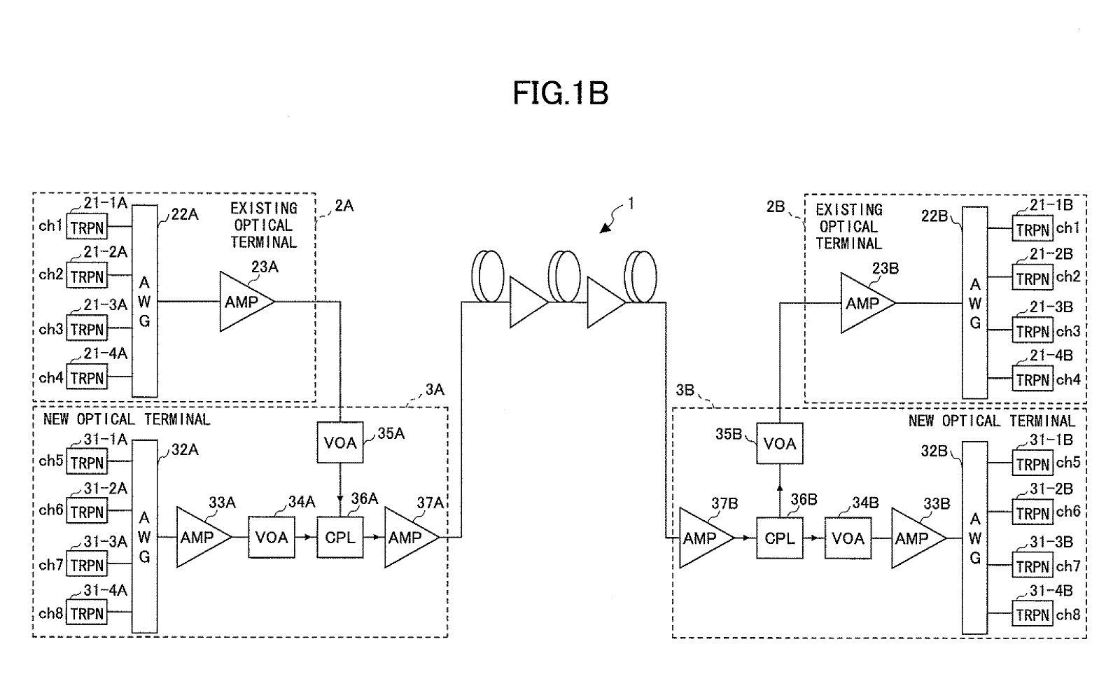

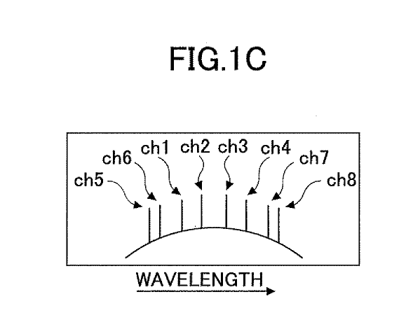

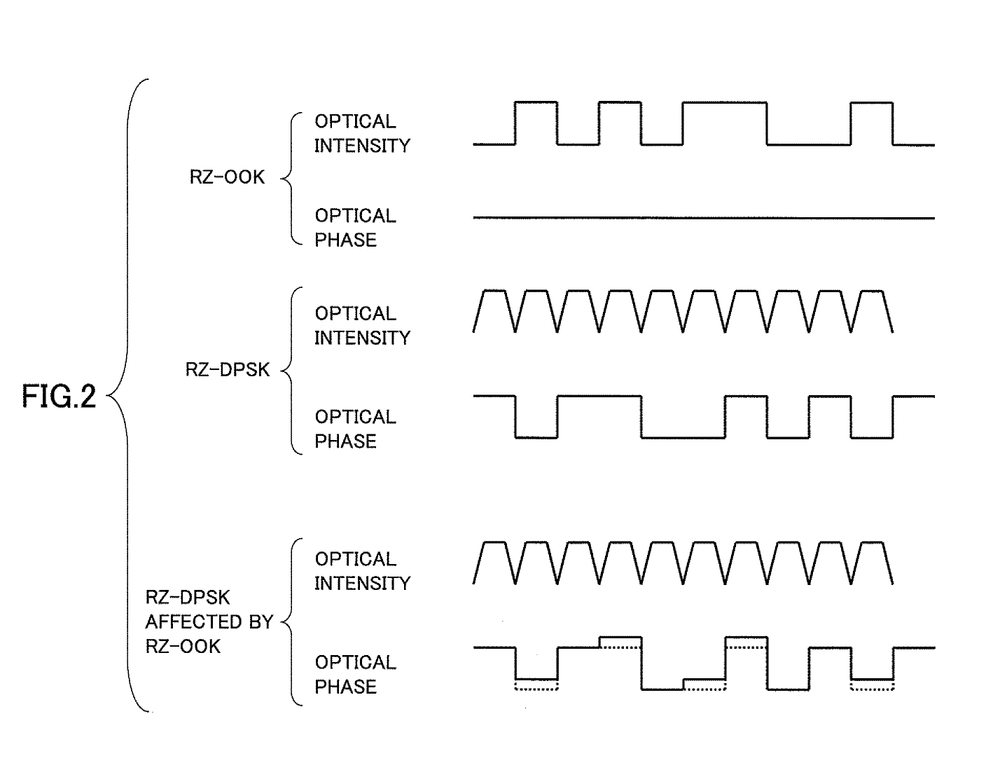

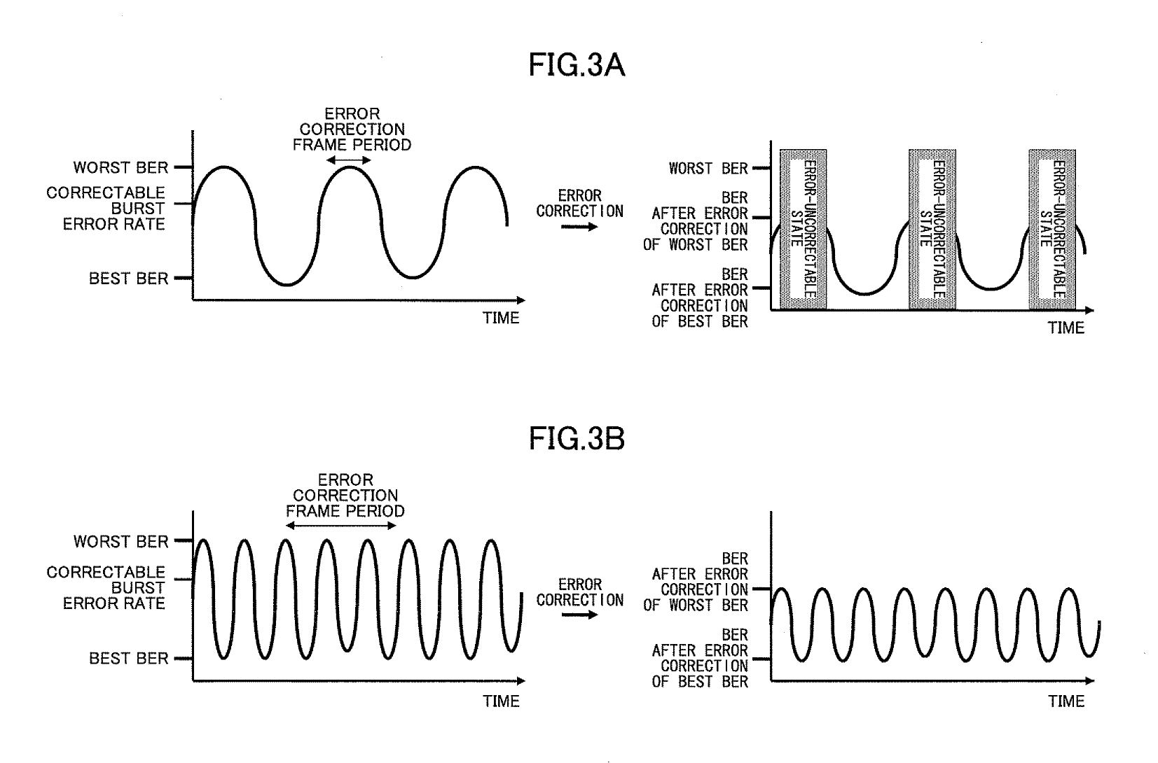

In FIG. 4, the configuration of the existing optical terminal 2A on the transmission side is the same as the configuration illustrated in FIG. 1B. Here, the existing channels ch1 through ch4 employ the intensity-modulated RZ-OOK scheme. The existing optical terminal 2B on the reception side also has a similar configuration.

A new optical terminal 3A on the transmission side has new channels ch5 through ch8 employing the phase-modulated RZ-DPSK scheme. The relationships between these new channels and the existing channels ch1 through ch4 are supposed to be the same as those illustrated in FIG. 1C. The configuration of the new optical terminal 3A is similar to that illustrated in FIG. 1B, with a few differences. Such differences include the provision of polarization scramblers 301-2 and 301-3 immediately after the transponders 31-2A and 31-3A corresponding to the new channels ch6 and ch7, which suffer XPM from the existing channels ch1 and ch4, respectively. Further, a signal generating unit 302 and a drive unit 303 are provided to drive the polarization scramblers 301-2 and 301-3. The polarization scramblers 301-2 and 301-3 change polarization in response to a drive signal supplied from the drive unit 303 with respect to the optical outputs of the transponders 31-2A and 31-3A, respectively. The period of polarization is equal to the period of the drive signal, and the magnitude of a polarization change is responsive to the amplitude of the drive signal. The configuration of the new optical terminal 3B on the reception side is the same as that illustrated in FIG. 1B. In this embodiment, modification such as the provision of polarization scramblers or the like is not made to the new optical terminal 3B.

The frequency of the drive signal supplied from the drive unit 303 to the polarization scramblers 301-2 and 301-3 is determined as follows. It suffices for the polarization scramblers 301-2 and 301-3 to change polarization to create at least two portions suffering no burst error in an error correction frame, thereby making it possible to perform error correction. Thus, the following relationship suffices.

Drive Frequency>(Bit Rate of Phase Modulated Signal)/(Error Correction Frame Length)×2

Here, (Bit Rate of Phase Modulated Signal)/(Error Correction Frame Length) represents the frequency at which the error correction frame is repeated because the error correction frame is carried by the bit rate of a phase-modulated signal. Doubling the above-noted value is intended to create polarization changes equivalent to at least two cycles within one error correction frame. With this arrangement, the length of bust errors is set shorter than the error correction frame period, and, also, the number of portions having no burst error is two or more in one error correction frame. The occurrence of error-uncorrectable state can thus be prevented.

What is supposed to be done by use of the polarization scramblers 301-2 and 301-3 is to change relative polarization between the intensity-modulated channels ch1 and ch4 and the phase-modulated channels ch6 and ch7, respectively. In place of the polarization scramblers 301-2 and 301-3 in the new optical terminal 3A, polarization scramblers may be inserted immediately after the transponders 21-1A and 21-4A corresponding to the respective channels ch1 and ch4 in the existing optical terminal 2A. In this case, the polarization scramblers 301-2 and 301-3 may be retained in the new optical terminal 3A so that both the new optical terminal 3A and the existing optical terminal 2A perform polarization scrambling. With such arrangement, there is a need to use different drive frequencies. It should be noted that the provision of a polarization scrambler after combining the phase-modulated signal and the intensity-modulated signal at the optical coupler 36A does not provide the intended effect.

Although the RZ-DPSK scheme is used as an example of a phase modulation scheme, other schemes such as DPSK, DQPSK, or RZ-DQPSK can properly be used. Further, although the RZ-OOK scheme is used as an example of an intensity modulation scheme, other schemes such as NRZ can properly be used.

In the above description, only the effect of the channel ch1 on the channel ch6 and the effect of the channel ch4 on the channel ch7 have been taken into consideration. If cumulative chromatic dispersion is small, however, an effect on other new channels ch5 and ch8 may also have to be considered. Such case can be taken care of similarly to the manner described above to achieve the same result. Further, the above description has been given with respect to a case in which the channel ch5 through ch8 using the RZ-DPSK scheme are arranged on both sides of the channels ch1 through ch4 using the RZ-OOK scheme. Even if the channels using the RZ-OOK scheme are arranged on both sides of the channels using the RZ-DPSK scheme, the above-described configuration or similar configuration can be used to achieve the same result. Any arrangement of wavelengths can be taken care of similarly to the manner as described above.

The above description has been given with respect to a case in which two groups of signals inclusive of a group of one or more phase modulated signals and a group of one or more intensity modulated signals are present. This is not a limiting example, and the present embodiment is applicable to a case in which three or more groups of signals are present. When three more groups are present, the present embodiment is applied similarly to the manner described above by focusing attention on the combination of a phase modulated signal and an intensity modulated signal.

### Second Embodiment

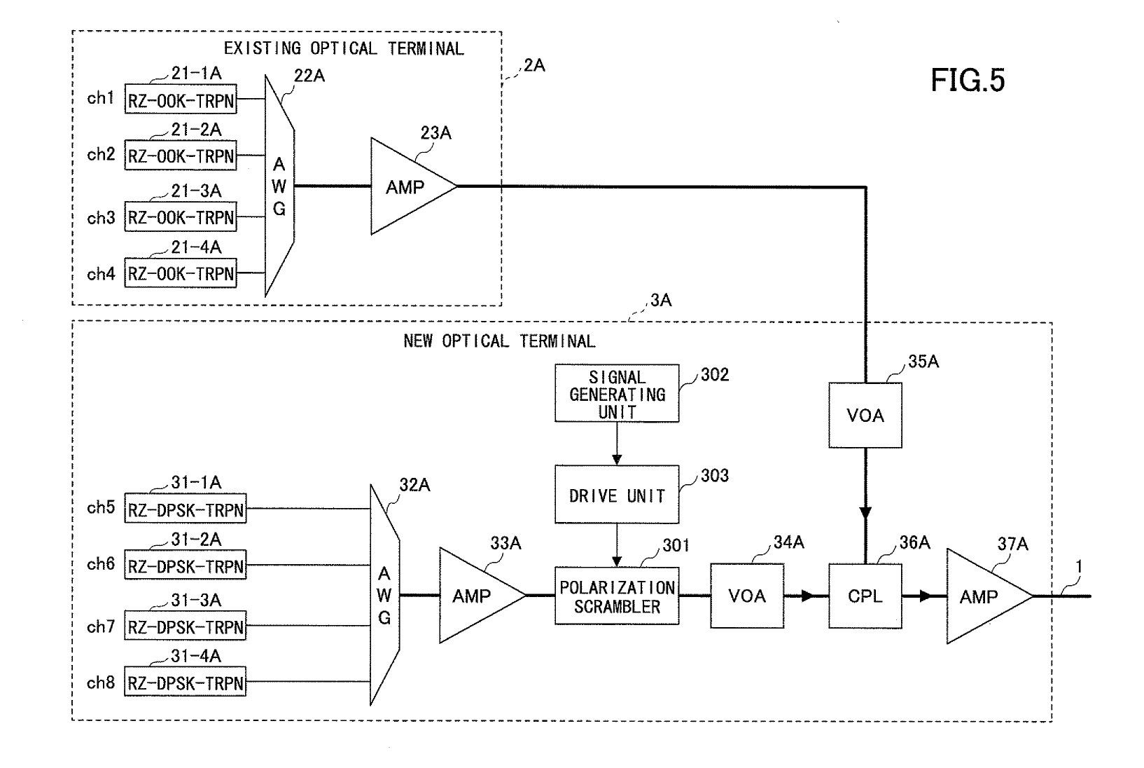

FIG. 5 is a drawing showing an example of the configuration of a transmission side of a system according to a second embodiment. In this embodiment, a polarization scrambler is inserted into a path after multiplexing, rather than being provided separately for each of the new channels that suffers XPM from an adjacent existing channel. This configuration can provide the same result since the intended effect of polarization scrambling is attributable to changes in relative polarization between an intensity modulated signal and a phase modulated signal.

In FIG. 5, the optical outputs of the transponders 31-1A through 31-4A corresponding to the new channels ch5 through ch8 are directly supplied to the multiplexer/demultiplexer unit 32A. A polarization scrambler 301 is provided at the output of the optical amplifier 33A situated after the multiplexer/demultiplexer unit 32A. Configurations other than what is described above are the same as those in the first embodiment illustrated in FIG. 4.

Instead of providing the polarization scrambler 301 in the new optical terminal 3A, a polarization scrambler may be inserted after the optical amplifier 23A in the existing optical terminal 2A. In this case, the polarization scrambler 301 may be retained in the new optical terminal 3A so that both the new optical terminal 3A and the existing optical terminal 2A perform polarization scrambling. With such arrangement, there is a need to use different drive frequencies. It should be noted that the provision of a polarization scrambler after combining the phase-modulated signal and the intensity-modulated signal at the optical coupler 36A does not provide the intended effect.

Although the RZ-DPSK scheme is used as an example of a phase modulation scheme, other schemes such as DPSK, DQPSK, or RZ-DQPSK can properly be used. Further, although the RZ-OOK scheme is used as an example of an intensity modulation scheme, other schemes such as NRZ can properly be used.

In the above description, only the effect of the channel ch1 on the channel ch6 and the effect of the channel ch4 on the channel ch7 have been taken into consideration. If cumulative chromatic dispersion is small, however, an effect on other new channels ch5 and ch8 may also have to be considered. Such case can be taken care of similarly to the manner described above to achieve the same result. Further, the above description has been given with respect to a case in which the channel ch5 through ch8 using the RZ-DPSK scheme are arranged on both sides of the channels ch1 through ch4 using the RZ-OOK scheme. Even if the channels using the RZ-OOK scheme are arranged on both sides of the channels using the RZ-DPSK scheme, the above-described configuration or similar configuration can be used to achieve the same result. Any arrangement of wavelengths can be taken care of similarly to the manner as described above.

The above description has been given with respect to a case in which two groups of signals inclusive of a group of one or more phase modulated signals and a group of one or more intensity modulated signals are present. This is not a limiting example, and the present embodiment is applicable to a case in which three or more groups of signals are present. When three more groups are present, the present embodiment is applied similarly to the manner described above by focusing attention on the combination of a phase modulated signal and an intensity modulated signal.

### Third Embodiment

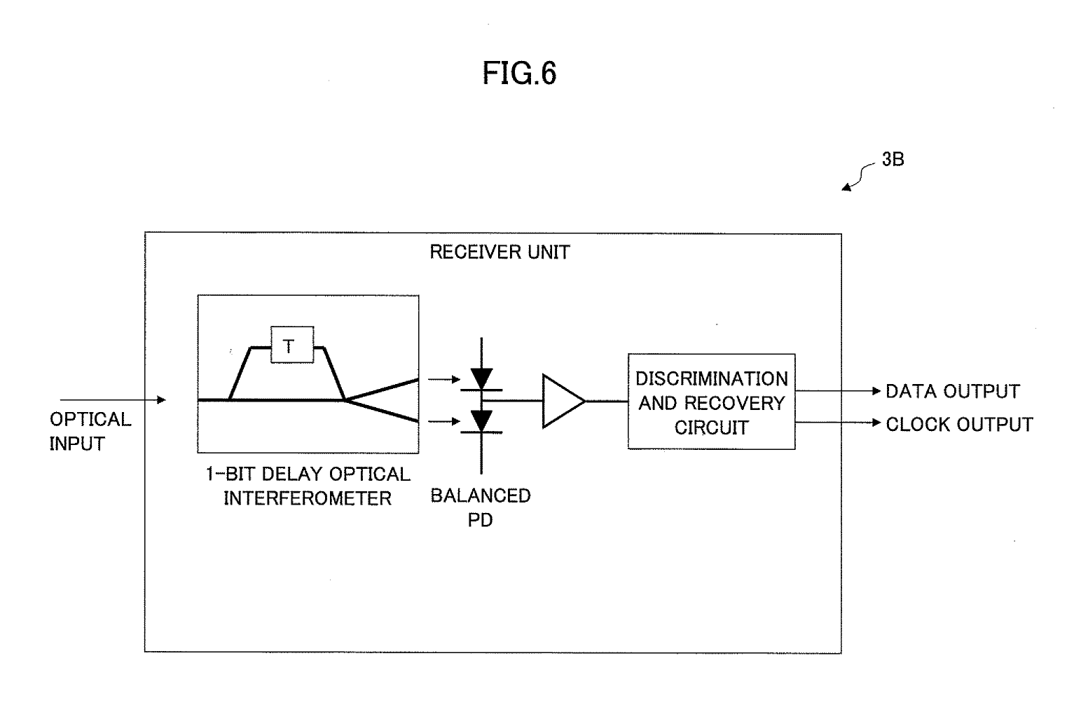

The third embodiment is directed to a configuration in which the receiver unit of a transponder in the new optical terminal 3B on the reception side is configured to cope with polarization dependency. FIG. 6 is a drawing showing an example of the configuration of a receiver unit of a reception-side transponder using the RZ-DPSK scheme. A 1-bit delay optical interferometer is provided for an optical input to divide the output path according to “0/1” of the optical signal, and a pair of balanced photodiodes PD is used to receive light. The output of the balanced photodiodes PD is amplified for provision to a discrimination and recovery circuit. The 1-bit delay optical interferometer is generally implemented by use of a thin optical waveguide formed on a substrate. The waveguide characteristics may vary depending on the polarization of incident light. Consequently, the level of the light received by the balanced photodiodes may be affected by the presence of polarization scrambling, resulting in possible erroneous detection.

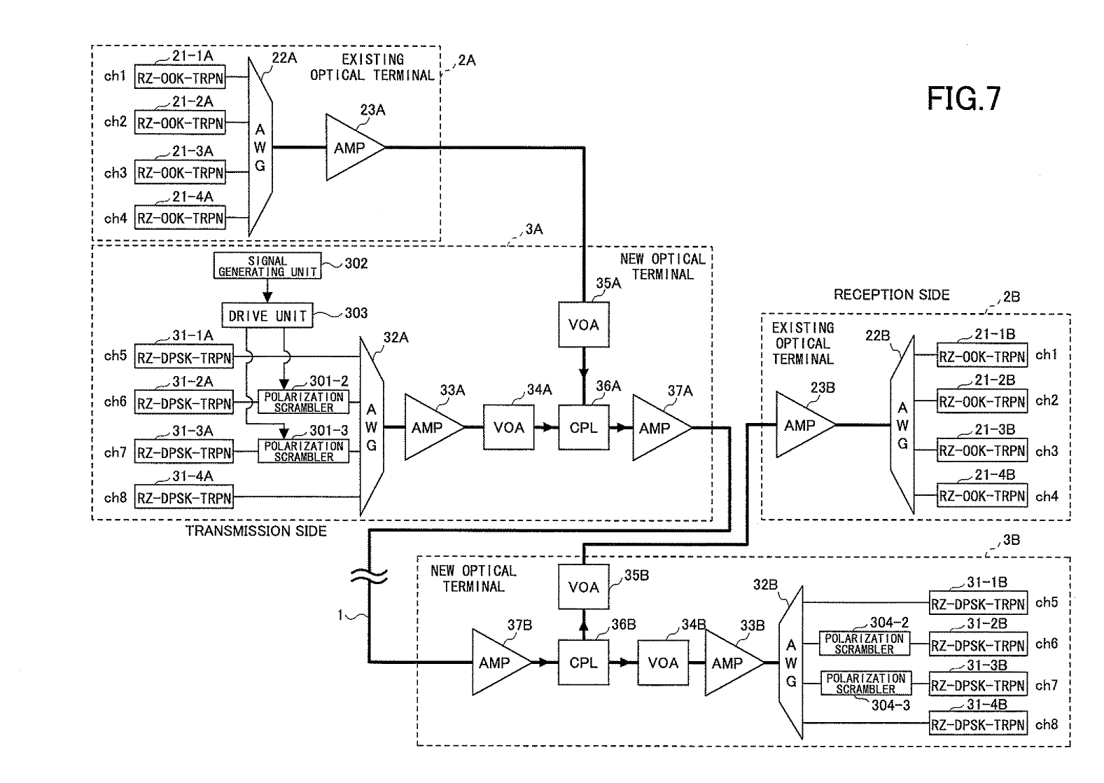

FIG. 7 is a drawing showing an example of the configuration of a system according to a third embodiment of the present invention. In addition to the configuration of the first embodiment illustrated in FIG. 4, polarization scramblers 304-2 and 304-3 are inserted between the multiplexer/demultiplexer unit 32B and the transponders 31-2B and 31-3B corresponding to the channels ch6 and ch7, respectively, in the new optical terminal 3B on the reception side. The polarization scramblers 304-2 and 304-3 are driven in synchronization with the transmission side by use of reverse sign, thereby canceling the polarization changes. Configurations other than what is described above are the same as those in the first embodiment illustrated in FIG. 4.

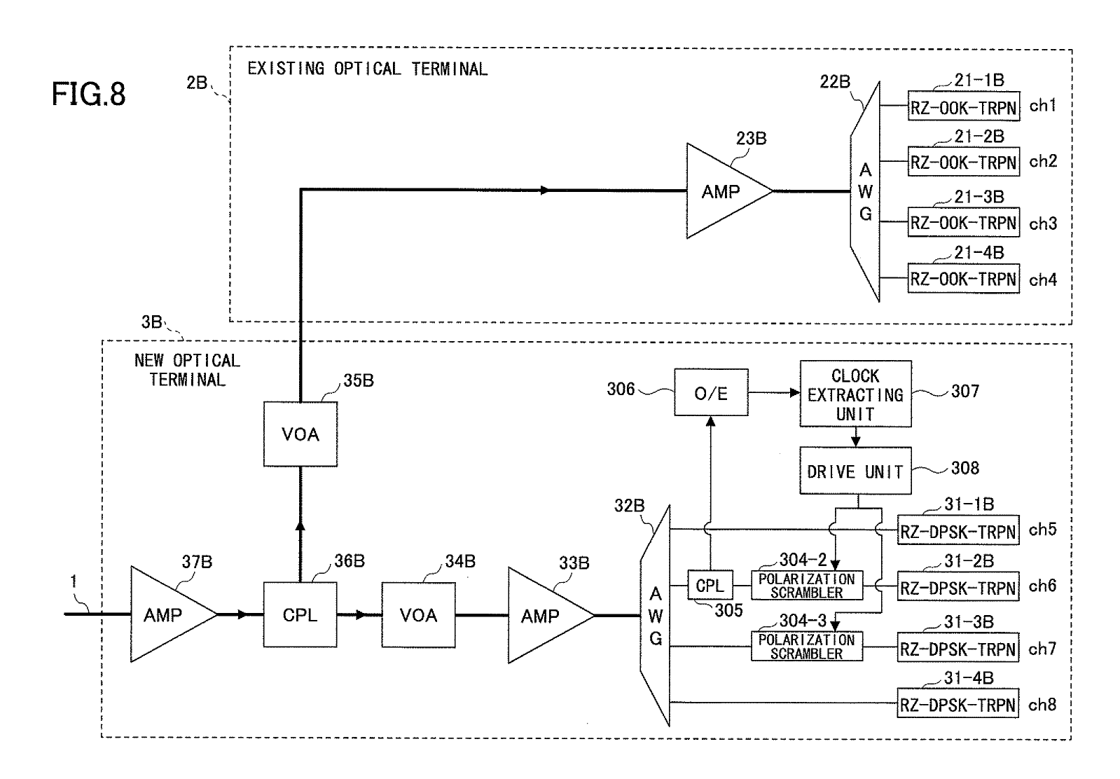

FIG. 8 is a drawing showing an example of the configuration that generates a drive signal for driving the polarization scramblers 304-2 and 304-3 on the reception side. An optical coupler 305 is provided before the polarization scrambler 304-2 (or 304-3) to divide the optical signal and supply one of the two signals to a photoelectric conversion unit 306. A clock extracting unit 307 extracts a clock signal from the output signal of the photoelectric conversion unit 306. A drive unit 308 receives the clock signal to drive the polarization scramblers 304-2 and 304-3. The reason why the drive frequency can be detected from the received optical signal is because the polarization scrambling introduces a faint phase modulation, which is changed into an intensity modulation during transmission through the optical fiber.

In the case where a polarization scrambler is inserted into the path after the multiplexing performed in the new optical terminal 3A on the transmission side as illustrated in FIG. 5, a polarization scrambler for canceling polarization changes may be inserted before the demultiplexing performed in the new optical terminal 3B on the reception side (i.e., before the multiplexer/demultiplexer unit 32B).

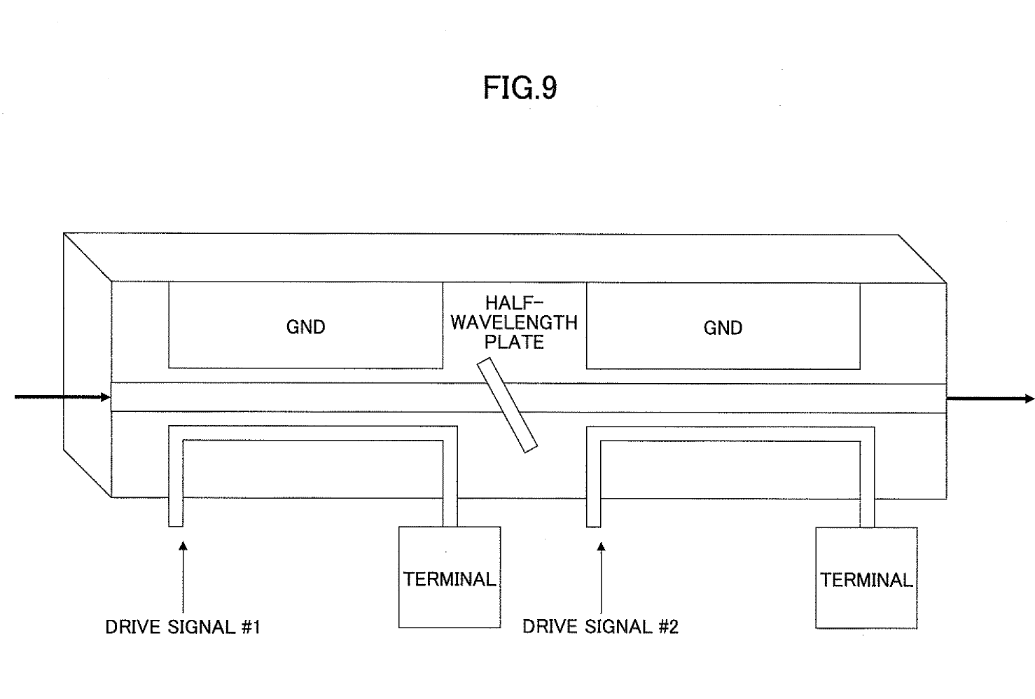

If there is polarization dependency in the polarization scramblers used in the new optical terminal 3A on the transmission side, polarization scrambling may not be properly performed, which may result in a failure to perform sufficient cancellation in the new optical terminal 3B on the reception side. In such a case, a polarization-independent polarization scrambler as shown in FIG. 9 may be used in the transmission side and the reception side to improve the effect of cancellation. In FIG. 9, the polarization-independent polarization scrambler includes a half-wavelength plate provided in a waveguide on a substrate made of LiNbO₃ or the like. A pair of a ground electrode and a drive electrode, which are arranged across the waveguide, is provided for each of the path extending from the input terminal to the half-wavelength plate and the path extending from the half-wavelength plate to the output terminal. The two drive electrodes receive the same drive signal. With this configuration, the polarization of light rotates 90 degrees by passing through the half-wavelength plate, so that a polarization component that is not effectively phase-modulated in the first half of the path is effectively phase-modulated in the second half of the path, thereby providing proper polarization scrambling.

In the case where a polarization scrambler is provided in the existing optical terminal 2A (either for each channel or for the multiplexed signal), the arrangement as described above is not necessary because the new additional channels do not experience polarization changes.

### Fourth Embodiment

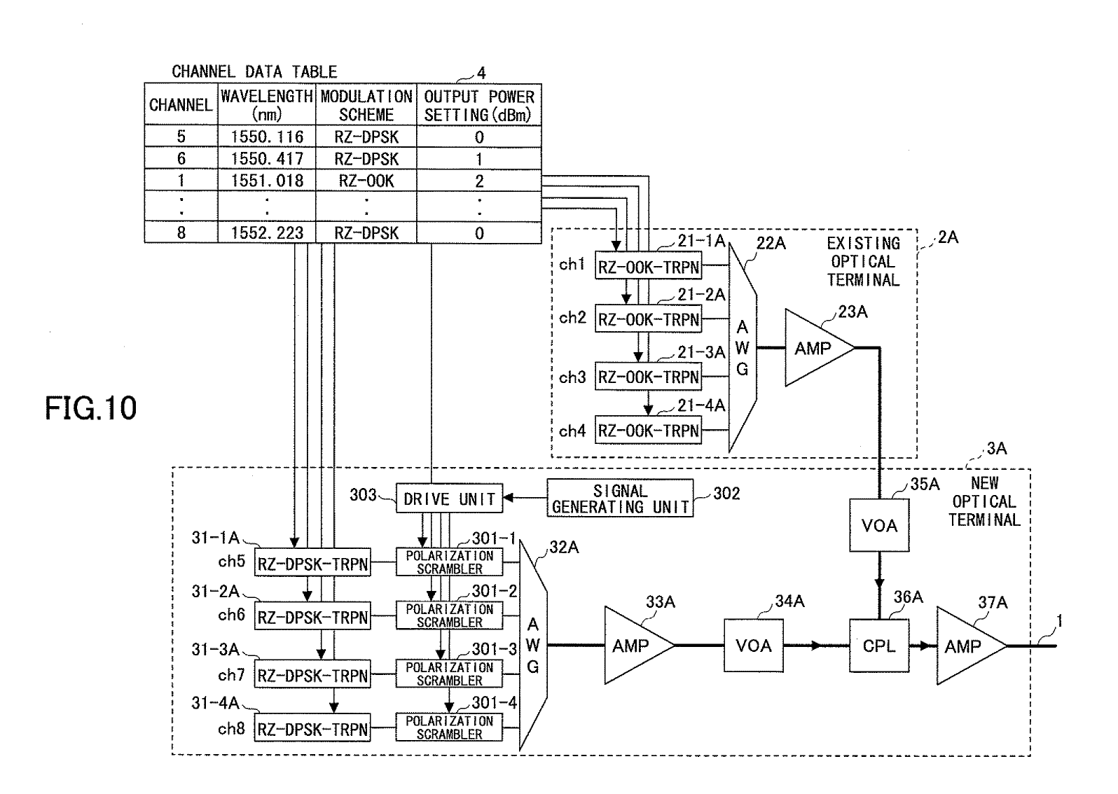

FIG. 10 is a drawing showing an example of the configuration of a transmission side of a system according to a fourth embodiment. Polarization scramblers are coupled in one-to-one correspondence to the outputs of the transponders on the transmission side. One or more of the polarization scramblers are enabled for the channels requiring polarization scrambling in response to settings stored in a channel data table. From the viewpoint of operation principle, the fourth embodiment may be characterized as an improvement over the first embodiment shown in FIG. 4.

In FIG. 10, a channel data table 4 stores a wavelength, a modulation scheme, an output setting, and so on for each channel. The transponders 21-1A through 21-4A of the existing optical terminal 2A and the transponders 31-1A through 31-4A of the new optical terminal 3A use a wavelength, a modulation scheme, and an output as selected in response to the settings stored in the channel data table 4. The drive unit 303 of the new optical terminal 3A identifies one or more channels suffering the effect of XPM propagating from an intensity modulated signal to a phase modulated signal based on the wavelength, modulation scheme, and output setting defined in the channel data table 4. The drive unit 303 supplies a drive signal to one or more of the polarization scramblers 301-1 through 301-4 corresponding to the identified channels to perform polarization scrambling.

A similar configuration may also be employed in the new optical terminal 3B on the reception side to cancel the effect of polarization dependency.

Further, a similar configuration may be applied to the existing optical terminal 2A.

### Fifth Embodiment

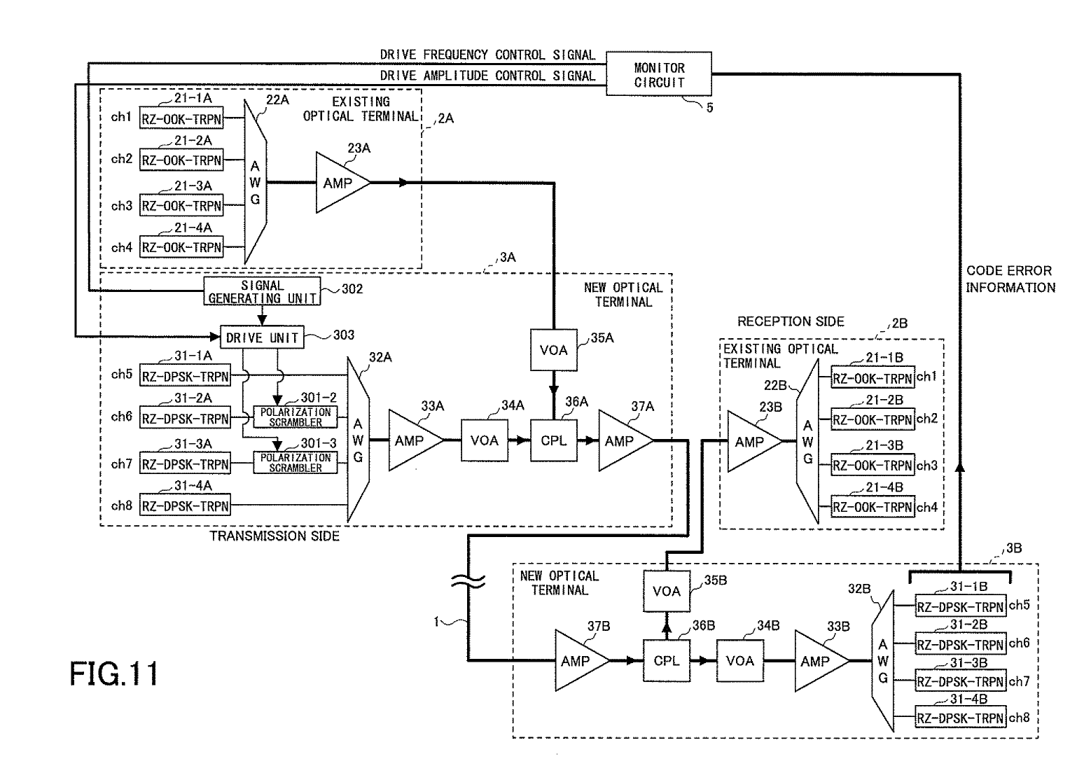

FIG. 11 is a drawing showing an example of the configuration of a system according to a fifth embodiment. The fifth embodiment controls the drive frequency and amplitude for polarization scrambling on the transmission side in response to code error information detected on the reception side, thereby achieving optimum signal quality. This embodiment is constructed based on the configuration shown in FIG. 4. The present embodiment may alternatively be applied to the configuration in which polarization scramblers are provided in the existing optical terminal 2A, the configuration in which a polarization scrambler is provided after multiplexing (as shown in FIG. 5), or the configuration in which polarization scramblers are provided in one-to-one correspondence to the respective channels (as shown in FIG. 10).

In FIG. 11, a monitor circuit 5 acquires code error information from the new optical terminal 3B on the reception side. The monitor circuit 5 controls the drive frequency (oscillating frequency) of the signal generating unit 302 and the drive amplitude of the drive unit 303 in the new optical terminal 3A on the transmission side so as to adjust the detected code error rate to a proper code error rate. The acquisition of code error information from the new optical terminal 3B is performed by use of another channel directed from the new optical terminal 3B to the new optical terminal 3A.

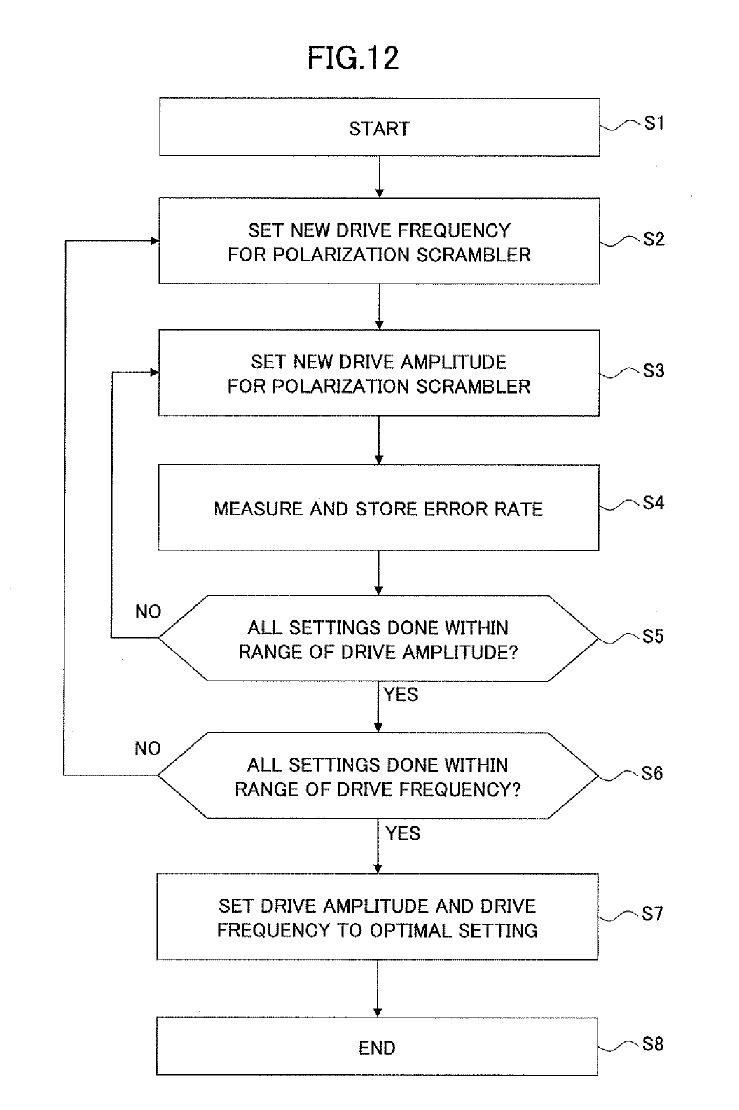

FIG. 12 is a flowchart showing an example of the process performed by the monitor circuit 5. In FIG. 12, the monitor circuit 5 starts operation (step S1). The monitor circuit 5 sets a new drive frequency for the polarization scramblers 301-2 and 301-3 in the signal generating unit 302 (step S2), and also sets a new drive amplitude in the drive unit 303 (step S3).

The monitor circuit 5 then measures a error rate and stores the measured error rate in memory (step S4). The monitor circuit 5 checks whether the above-described settings are made with respect to every point within the range of drive amplitude (step S5). If the settings are not made with respect to every point (NO in step S5), the monitor circuit 5 sets a new drive amplitude (step S3).

If the settings are made with respect to every point within the range of drive amplitude (YES in step S5), the monitor circuit 5 checks whether the above-described settings are made with respect to every point within the range of drive frequency (step S6). If the settings are not made with respect to every point (NO in step S6), the monitor circuit 5 sets a new drive frequency (step S2).

If the settings are made with respect to every point within the range of drive frequency (YES in step S6), the monitor circuit 5 sets a drive frequency and drive amplitude to the optimum drive frequency and drive amplitude (step S7). With this, the procedure comes to an end (step S8).

The above-described procedure may be performed at constant intervals thereby to maintain optimum conditions responsive to changes in the environmental conditions.

Embodiments of the present invention have been described heretofore for the purpose of illustration. The present invention is not limited to these embodiments, but various variations and modifications may be made without departing from the scope of the present invention. The present invention should not be interpreted as being limited to the embodiments that are described in the specification and illustrated in the drawings.

What is claimed is:

1. A wavelength division multiplexing transmission system in which a first channel using an intensity modulation scheme and a second channel using a phase modulation scheme are present, comprising:
a polarization scrambler inserted into a signal path of either one of the first channel and the second channel to perform polarization scrambling; and
a drive unit configured to drive the polarization scrambler at frequency greater than or equal to a value defined as: (bit rate of phase modulated signal)/(error correction frame length)−2.

2. The wavelength division multiplexing transmission system as claimed in claim 1, wherein the polarization scrambler is inserted into the signal path between an output of a transponder for the second channel and a point where multiplexing occurs in an optical terminal on a transmission side.

3. The wavelength division multiplexing transmission system as claimed in claim 1, wherein the polarization scrambler is inserted into the signal path between an output of a transponder for the first channel and a point where multiplexing occurs in an optical terminal on a transmission side.

4. The wavelength division multiplexing transmission system as claimed in claim 1, wherein the polarization scrambler is inserted into the signal path after a point where multiplexing occurs for the second channel in an optical terminal on a transmission side.

5. The wavelength division multiplexing transmission system as claimed in claim 1, wherein the polarization scrambler is inserted into the signal path after a point where multiplexing occurs for the first channel in an optical terminal on a transmission side.

6. The wavelength division multiplexing transmission system as claimed in claim 2, further comprising another polarization scrambler configured to cancel said polarization scrambling, said another polarization scrambler being inserted into a signal path corresponding to the second channel between a point where demultiplexing occurs and a transponder in an optical terminal on a reception side.

7. The wavelength division multiplexing transmission system as claimed in claim 4, further comprising another polarization scrambler configured to cancel said polarization scrambling, said another polarization scrambler being inserted into a signal path for a phase-modulated channel before a point where demultiplexing occurs in an optical terminal on a reception side.

8. The wavelength division multiplexing transmission system as claimed in claim 1, wherein the polarization scrambler has polarization-independent characteristics.

9. The wavelength division multiplexing transmission system as claimed in claim 2, wherein the polarization scrambler is inserted into the signal path between an output of a transponder for each said second channel and a point where multiplexing occurs in an optical terminal on a transmission side, and the polarization scrambler is enabled in response to a setting defined in a channel data table.

10. The wavelength division multiplexing transmission system as claimed in claim 1, further comprising a monitor circuit configured to change drive frequency and drive amplitude of the drive unit in response to code error information detected on a reception side.

11. A method of controlling a wavelength division multiplexing transmission system in which a first channel using an intensity modulation scheme and a second channel using a phase modulation scheme are present, said method comprising:
driving a polarization scrambler inserted into a signal path of either one of the first channel and the second channel at frequency greater than or equal to a value defined as: (bit rate of phase modulated signal)/(error correction frame length)×2.
